(19) United States
(12) Patent Application Publication
(10) Pub. No.: US 2015/0260064 A1
(43) Pub. Date: Sep. 17, 2015

(54) FILTRATION OF GASOLINE DIRECT INJECTION ENGINE EXHAUSTS WITH HONEYCOMB FILTERS

(71) Applicant: DOW GLOBAL TECHNOLOGIES LLC, Midland, MI (US)

(72) Inventors: Stephen F. Majkowski, Rochester Hills, MI (US); Ingo Mikulic, Frankfurt (DE); Heinricus J. Koelman, D-61462 Konigstein (DE); De-Wei Yin, Midland, MI (US)

(21) Appl. No.: 14/431,005

(22) PCT Filed: Nov. 25, 2013
(86) PCT No.: PCT/US2013/071680

§ 371 Date: Mar. 25, 2015

Related U.S. Application Data
(60) Provisional application No. 61/731,761, filed on Nov. 30, 2012.

(51) Int. Cl. F01N 3/022; B01D 46/24

(52) U.S. Cl. CPC F01N 3/0222; B01D 46/247; B01D 2046/2477; B01D 2046/2481

(57) ABSTRACT

Particulate matter is removed from the exhaust gas of a gasoline direct injection (GDI) engine, by introducing a particulate-containing exhaust gas into an inlet end of a ceramic honeycomb containing multiple axially-extending cells that are defined by intersecting porous walls, passing the exhaust gas through at least one such porous wall to trap the particulate matter in the porous wall, and then discharging the exhaust gas from an outlet end of the ceramic honeycomb. The porous walls of the ceramic honeycomb have a wall thickness of 150 to 750 μm, the honeycomb has an effective permeability of at least 0.8 10-12.?m2? and the ceramic honeycomb contains from 45,000 to 230,000 cells per square meter of cross-sectional area

The present invention relates to the filtration of gasoline direct injection engine exhausts.

It is known to use various types of ceramic filters to remove particulate matter from diesel engine exhaust. The filters, commonly known as “honeycombs”, have axial cells that extend the length of the filter from an inlet end to an outlet end. The cells are defined and separated by porous walls. The cells are plugged in a pattern that forces exhaust entering the filter to pass though a cell wall before it escapes from the filter. Particulate matter is captured by the cell walls.

It is far less common to employ such particulate filters in gasoline engines, which traditionally have been mainly port fuel injected (PFI) types. PFI engines, when operated properly, produce very little particulate matter, and so there is little need for a particulate filter. However, a newer type of gasoline engine, the so-called gasoline direct injection (GDI) engine, is gaining in market share at the expense of more conventional port fuel injected (PFI) engines. GDI engines have advantages over PFI engines under light load conditions such as are encountered during idling, when operating at constant speed or at low acceleration, and/or when traveling downhill. Under these conditions, GDI engines can be operated under leaner conditions than PFI engines. This potentially provides improvements in fuel economy and better performance during transient acceleration and deceleration.

A problem with GDI engines is that they tend to produce more particulate emissions than do PFI engines. Automotive emission standards in many jurisdictions require that most of these emissions be removed from the engine exhaust. As with diesel engines, this can be accomplished by passing the exhaust through a ceramic filter. However, ceramic filters designed for treating diesel exhaust perform inadequately in GDI systems. The reason for this is that GDI engines operate under very different conditions than diesel engines. A specific problem is the pressure drop seen across the filter. Diesel engines, which operate at very high compression ratios and therefore higher pressures, can tolerate these pressure drops without significant loss of performance. GDI engines, however, operate at lower compression ratios and lower pressures. The pressure drop across the particulate filter can have a significant effect on GDI engine performance, reducing power output and increasing fuel consumption.

Another important difference is that fewer particles are formed in a GDI engine than in a diesel engine, and those particles tend to be significantly smaller (and therefore more difficult to filter). With diesel particulate filters, the most efficient filtration is seen not with clean filters, but with filters that have been operating for a while and have accumulated a “soot cake”. GDI filters tend not to accumulate much of a soot cake, and therefore need to efficiently remove the very small particulates produced by GDI engines without benefit of the soot cake. One wants to avoid forming a thick soot cake in GDI engine filters in any event, to avoid increasing the backpressure.

Therefore, a particulate filter that operates efficiently at low pressure drop to effectively remove particulate matter from a GDI engine exhaust is desired.

This invention is a method of removing particulate matter from the exhaust gas of a gasoline direct injection (GDI) engine, comprising introducing a particulate-containing exhaust gas into an inlet end of a ceramic honeycomb containing multiple axially-extending cells that are defined by intersecting porous walls, passing the exhaust gas through at least one such porous wall to trap the particulate matter in the porous wall, and then discharging the exhaust gas from an outlet end of the ceramic honeycomb, wherein:

the porous walls of the ceramic honeycomb have a wall thickness of 150 to 750 μm, the honeycomb has an effective permeability of at least 0.8×10⁻¹² m² and the ceramic honeycomb contains from 45,000 to 230,000 cells per square meter of cross-sectional area.

In certain embodiments, the ceramic honeycomb is characterized in having a viscous resistance (Rᵥ) value determined as set forth below, of less than 2×10⁷ m⁻¹. Surprisingly, the high permeability filter remains highly effective at removing particulate matter from GDI engine exhaust, while operating at low pressure drops that are needed for efficient operation of the engine.

For purposes of this invention, a gasoline direct injection (GDI) engine is an internal combustion engine in which the fuel (gasoline or gasoline-containing mixture) is ignited using a spark ignition system, and in which the fuel is injected directly into the cylinder(s) in the form of droplets prior to mixing with air and becomes mixed with the air within the cylinder. The GDI engine differs from a port fuel injected (PFI) engine in part because in a PFI engine the fuel and air are mixed before being introduced into the cylinder(s). It is believed that the direct introduction of fuel droplets contributes to increased particulate emissions seen in a GDI engine, relative to a PFI engine.

The GDI engine differs from a diesel engine in part because the fuel-air mixture in a GDI engine is spark-ignited during normal operation.

The GDI engine may be single or multicylindered. A multicylindered engine may have 2 or more cylinders, typically from 4 to 16 cylinders and, for automotive uses, most typically will contain 4 to 12 or 4, 6 or 8 cylinders. The GDI engine may be a two-stroke or four-stroke engine.

During operation, the fuel is combusted in the cylinder(s) of the GDI engine to form hot gases (mainly carbon dioxide and water) whose expansion powers the engine. At the end of each combustion cycle, the spent gases are removed from the cylinder(s) of the engine to form an exhaust gas stream which is discharged to the atmosphere. In multicylinder engines, the exhaust gases from multiple cylinders may be combined (as in an exhaust manifold) prior to being released. In automotive applications, the exhaust gases typically are conducted though a system of pipes to a release point above or at the rear of the vehicle.

In this invention, exhaust gas from the GDI engine is filtered by passing it through a porous wall filter prior to discharging the gas into the atmosphere. The porous wall filter is a ceramic honeycomb that contains multiple axially-extending cells. The axially-extending cells extend from an inlet end to an outlet end of the ceramic honeycomb. The inlet end of the ceramic honeycomb is the end at which the exhaust gases are introduced for filtration, and the outlet end is the end at which the exhaust gases are discharged after being filtered. The axially-extending cells are defined by intersecting porous walls, which act as the active filter medium. Most or all of the cells are plugged, typically at one end or the other but not both, and typically in an alternating pattern. The plugging forms inlet cells, which are open at the inlet end and closed at an outlet end. The plugging also forms outlet cells, which are open at the outlet end and closed at the inlet end. During operation of the engine, the engine exhaust gas enters the inlet cells of the ceramic honeycomb, passes through at least one of the intersecting porous cell walls into an outlet cell, and is discharged from the outlet cells at the outlet end of the honeycomb. Particulate removal occurs when the gas with entrained particulates passes through the porous cell walls, and the particulates are captured by the wall and removed from the gas.

The ceramic honeycomb is disposed within the exhaust system of the GDI engine, so exhaust gases from the engine pass through the ceramic honeycomb before being discharged into the atmosphere. The exhaust system includes one or a series of conducts which conduct the exhaust gas to the ceramic honeycomb and, once filtered, conduct the exhaust gas away from the ceramic honeycomb to the point(s) of discharge into the atmosphere. The exhaust system may include components such as sound abatement measures (such as one or more mufflers), one or more other scrubbing devices, one or more catalytic converters, and the like. The ceramic honeycomb typically is disposed in a canister or other container. The purpose of this canister or other container is to maintain the ceramic honeycomb at the desired position and orientation, and to prevent exhaust gases from escaping out of or passing around the periphery of the honeycomb. The can or other container normally includes an inlet through which exhaust gases are conducted to the inlet end of the ceramic honeycomb, and an outlet through which exhaust gases discharged from the outlet end of the ceramic honeycomb are conducted away.

The axially-extending cells of the ceramic honeycomb can have any convenient cross-sectional shape, such as circular, elliptical, polygonal (such as triangular, square, rectangular, pentagonal, hexagonal, octagonal, etc), and the like, or may instead have complex shapes such as “dumbbell” or similar shapes. Some of the cells may have different cross-sectional shapes than others, and may have different sizes (i.e., different cross-sectional areas) than the others. The cells preferably are rectangular, square or triangular in cross-section and most preferably are square in cross-section.

The ceramic honeycomb may be monolithic (i.e., formed in a single piece), or may be segmented, i.e. be an assembly of smaller honeycomb structures which are manufactured separately and then assembled together, usually using a ceramic cement to adhere the individual pieces together.

The ceramic honeycomb may have an outer peripheral “skin”. This skin may be formed by the exterior cell walls of the peripheral cells of the honeycomb. Alternatively, the skin can be an applied skin that is applied after the ceramic honeycomb has been manufactured.

The external dimensions of the ceramic honeycomb are selected in conjunction with the particular application. The cross-sectional area of the ceramic honeycomb may be, for example, 5 to 2000 cm², especially 75 to 500 cm². The length of the ceramic honeycomb may be, for example, 5 to 50 cm, especially 6 to 15 cm.

The porous intersecting walls of the ceramic honeycomb are made of a ceramic material. The ceramic material can be made of any that can withstand the temperature conditions encountered during operation without becoming permanently distorted or thermally degrading. The ceramic may be, for example, acicular mullite, non-acicular mullite, cordierite, alumina, zirconia, silicon carbide, silicon nitride, aluminum nitride, silicon oxynitride, silicon carbonitride, beta spodumene, aluminum titanate, a strontium aluminum silicate, a lithium aluminum silicate, silica, other alumino-silicate and the like, or a composite of any two or more thereof, such as a mullite-cordierite composite, a mullite-tialite composite, an acicular mullite-cordierite composite, an acicular mullite-tialite composite, and the like. Other examples may include composites of fibers with binders, such as mullite fibers, alumina fibers, aluminosilicate fibers, aluminozirconia fibers, along with appropriate binder materials such as alumina and the like.

In specific embodiments of this invention, the porous intersecting walls of the ceramic filter (that define the axially-extending cells) are acicular mullite, or a composite of an acicular mullite and one or more other ceramics. By “acicular”, it is meant that mullite is in the form of elongated needles joined together at least at some of their points of intersection. The pores in the intersecting walls are partially or wholly defined by the spaces between the intersecting needles. The acicular mullite needles may have an aspect ratio (length divided by median diameter) of at least 2, preferably at least 5, and most preferably 10 or more. The acicular mullite needles may have a median diameter of from 0.5 microns to 50 microns.

Examples of suitable acicular mullite honeycomb structures include those described in U.S. Pat. Nos. 5,194,154; 5,173,349; 5,198,007; 5,098,455; 5,340,516; 6,596,665 and 6,306,335; U.S. Patent Application Publication 2001/0038810; and International PCT publication WO 03/082773.

In the case of a composite of acicular mullite and one or more other ceramics, the other ceramic material preferably constitutes no more than 75%, more preferably no more than 50% and still more preferably no more than 10% by weight of such other ceramic(s). Among the other ceramics that may be present include non-acicular mullite, cordierite, tialite, alumina, zirconia, silicon carbide, silicon nitride, aluminum nitride, silicon oxynitride, silicon carbonitride, beta spodumene, aluminum titanate, a strontium aluminum silicate, a lithium aluminum silicate, silica, other alumino-silicate and the like. In some embodiments the porous walls of the ceramic honeycomb include an acicular mullite-cordierite composite as described in WO 2010/033763. In some embodiments, the porous walls of the ceramic honeycomb include an acicular mullite-tialite composite as described in WO 2012/135401.

In the case of a composite of acicular mullite and one or more other ceramics, the other ceramic(s) may be present (a) within the acicular mullite needle structure, (b) at grain boundaries between acicular mullite crystals, (c) at or near points of intersection of acicular mullite crystals, and/or (d) upon the surfaces of acicular mullite needles.

The porous walls of the ceramic honeycomb may be coated with or otherwise contain various functional materials which can be applied to the honeycomb, before or after applying the skin, using various methods. The functional materials may be organic or inorganic. Inorganic functional materials, particularly metals and metal oxides, are of interest as many of these have desirable catalytic properties, function as sorbents or perform some other needed function. Of particular interest are catalysts for the oxidation of carbon monoxide and/or unburned hydrocarbons to carbon dioxide and/or water (to produce a so-called “two-way” catalyst), and catalysts for the reduction of NOx compounds (which when coupled with a catalyst for the oxidation of carbon monoxide and unburned hydrocarbons forms a so-called “three-way” catalyst). Examples of specific functional materials include alumina, titania, barium, platinum, palladium, vanadium, silver, gold and the like. In an especially preferred embodiment, alumina and platinum, alumina and barium or alumina, barium and platinum can be deposited onto the honeycomb in one or more steps to form a filter that is simultaneously capable of removing particulates such as soot, NOx compounds, carbon monoxide and hydrocarbons from the exhaust gas.

The porous walls of the ceramic honeycomb are characterized by their wall thickness. For purposes of this invention, the “porous” walls are walls of the honeycomb through which the exhaust gases pass through during operation, and do not include, for example, peripheral walls and walls that are coated with a cement layer (such as a cement layer which adheres segments of a segmented honeycomb together). The porous walls have a thickness of at least 150 μm and up to 750 μm. Thinner walls are difficult to fabricate and lack sufficient mechanical strength, whereas thicker walls add unnecessary weight and unnecessarily increase pressure drop through the filter. The porous wall thickness preferably is at least 200 μm. The porous wall thickness preferably is no greater than 500 μm and still more preferably no greater than 450 μm. In the case of a segmented ceramic honeycomb, in which smaller honeycomb segments are bonded together along their axial lengths by one or more cement layers, the cement layer(s) are not counted toward the thickness of the porous walls.

In addition, the filter has an effective permeability κ of at least 0.8×10⁻¹² m², as determined at 22±2° C. with dry air as the flow gas. The effective permeability may be at least 1×10⁻¹² m². The effective permeability in some embodiments is as much as 10×10⁻¹² m² or as much as 5×10⁻¹² m². The filter in some embodiments exhibits a viscous resistance Rᵥ of less than 2×10⁷ m⁻¹, and in particular embodiments exhibits a viscous resistance of 5×10⁵ m⁻¹ to 2×10⁷ m⁻¹. The viscous resistance (Rᵥ) value is defined as:

$${R}_{v} = {lim}_{Q -> 0} \frac{Δ p}{μ ( Q / A )}$$

wherein Δp in Pa is the static pressure drop measured across the filter under steady-state incompressible and isothermal flow conditions, μ in Pa·s is the dynamic viscosity of the exhaust gas flowing through the filter, Q in m³/s is the actual volumetric flow rate of the exhaust gas, and A in m² is the gross frontal cross sectional area of the inlet end of the honeycomb.

For purposes of this invention, effective permeability κ and Rᵥ are measured on the honeycomb, including any applied coating as described before. Effective permeability κ is for purposes of this invention calculated as follows for a honeycomb having square cells and plugged at each end in a checkerboard pattern to form equal numbers of alternating inlet and outlet cells.

The cross-sectional area A of the plugged honeycomb is measured. The total length Lₜₒₜₐₗ of the filter and the average length l of the plugs is measured. The length of the permeable portion Lₚₑᵣₘ of the plugged filter is then calculated as the total filter length Lₜₒₜₐₗ minus 2l. The cell pitch c (i.e., the cell width d plus wall thickness w) is measured. The channel density σ is calculated as 1/c². The total number of channels N is measured.

Air is flowed through the plugged filter at varying actual volumetric flow rates. The highest volumetric flow rate does not exceed 800 μNd/ρ, where μ is the dynamic viscosity of the air in Pa·s, N is the number of channels, d is the effective cell width in meters (m) as calculated according to Equation 5 below, and ρ is density of the air in kg/m³, to ensure that the flow of gas through each channel in the plugged filter falls entirely within the laminar flow regime. The lowest volumetric flow rate is no higher than 200 μNd/ρ. The temperature T, actual volumetric flow rate Q and static pressure drop Δp across the plugged filter are measured. Measurements are made at least at three and preferably five or more actual volumetric flow rates. The density ρ and viscosity μ of the air are either measured or taken from reported values. The superficial flow velocity v is calculated as υ=Q/A. The kinetic energy per unit volume k is calculated as k=ρυ²/2. The cell pitch Reynolds number N_{Ru} is calculated as N_{Re}=ρcυ/μ for each flow rate. The Euler number N_{Eu} is calculated as N_{Eu}=Δp/k for each flow rate. The parameter b₋₁ is estimated by fitting the Reynolds and Euler numbers to the model

$${N}_{Eu} = \frac{{b}_{- 1}}{{N}_{Re}} + {b}_{0} \qquad ( 1 )$$

and using least-squares linear regression with x=N_{Re}⁻¹ and y=N_{Eu}. The overall viscous resistance Rᵥ of the plugged filter is then calculated as Rᵥ=b₋₁/2c.

An unplugged filter is then prepared by cutting off the ends of the plugged filter to remove the plugs. Air is flowed through the unplugged filter at 22±2° C. at varying flow rates as before. The temperature T, actual volumetric flow rate Q and static pressure drop Δp across the unplugged filter are measured. The density ρ and viscosity μ of the air are either measured or taken from reported values. The superficial flow velocity v is calculated as v=Q/A. The kinetic energy per unit volume k is calculated as k=ρυ²/2. The cell pitch Reynolds number N_{Re} is calculated as N_{Re}=ρcυ/μ for each flow rate. The Darcy number N_{Da} is calculated as N_{Da}=(Δp/k)(c/L_{unplugged}) for each flow rate, where L_{unplugged} is the length of the unplugged filter in meters (m). The parameter c₋₁ is estimated by fitting the Reynolds and Darcy numbers to the model

$${N}_{Da} = \frac{{c}_{- 1}}{{N}_{Re}} + {c}_{0} \qquad ( 2 )$$

and using least-squares linear regression with x=N_{Re}⁻¹ and y=N_{Da}. The channel-flow resistance per unit length R′_{ch} of the unplugged filter is then calculated as R′_{ch}=c₋₁/2c².

The ratio Rₚₑᵣₘ/R_{ch} is calculated from b₋₁, c₋₁, l/c and Lₚₑᵣₘ/c according to the equation

$$\frac{{R}_{perm}}{{R}_{ch}} = \frac{{b}_{- 1} - 4 ( l / c ) {c}_{- 1}}{( {L}_{perm} / c ) {c}_{- 1}} \qquad ( 3 )$$

The ratio R_{w}/R_{ch} is calculated from Rₚₑᵣₘ/R_{ch} according to the equation

$$\frac{{R}_{perm}}{{R}_{ch}} = 1 + \sqrt{\frac{2 {R}_{w}}{{R}_{ch}}} \frac{{( exp \sqrt{2 {R}_{ch} / {R}_{w}} + 1 )}^{2}}{{( exp \sqrt{2 {R}_{ch} / {R}_{w}} )}^{2} - 1} \qquad ( 4 )$$

The effective cell width d is calculated from the parameter c₋₁, the cross-sectional area A, the cell pitch c and the number of channels N according to the equation

$$d = {[ 56.908 ( \frac{{Ac}^{2}}{{c}_{- 1} N} ) ]}^{1 / 4} \qquad ( 5 )$$

From this the wall thickness w is calculated as w=c−d. The channel resistance R_{ch} is calculated from the length Lₚₑᵣₘ, the channel width d and the channel density σ according to the equation

$${R}_{ch} = 28.454 \frac{{L}_{perm}}{{d}^{4}} \frac{A}{N} \qquad ( 6 )$$

The wall resistance R_{w} is calculated by multiplying R_{ch}, as calculated by equation 6 by the value of the R_{w}/R_{ch} as calculated according to equation 4. The effective wall permeability κ is then calculated from the wall resistance R_{w}, the calculated wall thickness w, the effective channel width d and the channel density σ according to the equation

$$κ = \frac{1}{4} \frac{1}{{R}_{w}} \frac{w}{d {L}_{perm}} \frac{A}{N} \qquad ( 7 )$$

This calculation can be performed equivalently starting with an unplugged filter. In such a case, measurements as described are first made on the unplugged filter. The filter is then plugged on each end in a checkerboard fashion to form inlet and outlet cells, and measurements are then made on the plugged filter. κ and Rᵥ are then calculated in analogous manner.

The method can be adapted to other cell cross-sectional shapes through adjustment of the coefficient in equations (5), (6) and (7) as appropriate for the particular cell cross-sectional shape.

The ceramic honeycomb has a cell density of 45,000 to 230,000 cells per square meter of cross-sectional area. A preferred cell density is 45,000 to 200,000 cells per square meter of cross-sectional area and an even more preferred cell density is 60,000 to 155,000 cells per square meter of cross-sectional area. Cell density for purposes of this invention is defined according to the relationship σ=N/A, wherein N is the number of cells contained within cross-sectional area A, and A is the cross-sectional area of the honeycomb (including the area of cell and cell walls). When the cells are square the cell density can be equivalently calculated as σ=1/(d+w)², wherein σ is the cell density in m⁻², d is the effective width of the cells in m and w is the thickness in m of the porous walls.

Methods for making ceramic honeycombs are well known and in general can be used to produce ceramic honeycombs for use in this invention. In general, particulate precursors for the ceramic material(s) are blended with a carrier liquid to form an extrudable mixture. The extrudable mixture may contain various processing aids such as binders, rheology modifiers and the like as may be necessary or desirable. The extrudable mixture is then extruded to form a green body which has the desired cellular geometry. The green body is then fired in one or more steps to produce the honeycomb. Conditions for the various firing steps are of course selected in accordance with the particular type of ceramic being formed. In general, suitable precursors and firing conditions such as are known in the art are useful.

It may be desirable or necessary to include one or more porogens in the extrudable mixture, in order to obtain the necessary permeability, especially when the ceramic lacks an acicular structure. Porogens can be generally described as solid (at 25° C.) materials that under the conditions of the firing step(s) degrade, volatilize or otherwise become converted into gases. The conversion of the porogen to gases creates voids in the ceramic and increases its permeability.

Suitable methods for making ceramic honeycombs are described, for example, in U.S. Pat. Nos. 5,194,154; 5,173,349; 5,198,007; 5,098,455; 5,340,516; 6,596,665, 6,306,335, 7,713,897; U.S. Patent Application Publication 2001/0038810; and International PCT publication WO 03/082773. Suitable methods for applying a cement skin to such a ceramic honeycomb are described, for example, in U.S. Pat. No. 7,083,842 and WO 2011/008461. Typically, a ceramic cement composition, which may contain various particulate and/or fibrous filler materials, is applied to the peripheral surface of the ceramic honeycomb and fired to produce the skin.

Functional materials can be applied to the skinned honeycomb by, for example impregnating the honeycomb with a solution of a salt or acid of the metal, and then heating or otherwise removing the solvent and, if necessary calcining or otherwise decomposing the salt or acid to form the desired metal or metal oxide. Alumina can be deposited by impregnating the honeycomb with colloidal alumina, followed by drying, typically by passing a gas through the impregnated body. Other ceramic coatings such as titania can be applied in an analogous manner. Metals such as barium, platinum, palladium, vanadium, silver, gold and the like can be deposited on the composite body by impregnating the honeycomb (the internal walls of which are preferably coated with alumina or other metal oxide) with a soluble salt of the metal, such as, for example, platinum nitrate, gold chloride, rhodium nitrate, tetraamine palladium nitrate, barium formate, followed by drying and preferably calcination. Catalytic converters for power plant exhaust streams, especially for vehicles, can be prepared from the skinned honeycomb in that manner. Suitable methods for depositing various inorganic materials onto a honeycomb structure are described, for example, in US 205/0113249 and WO2001045828.

The following examples are provided to illustrate the invention, but are not intended to limit the scope thereof. All parts and percentages are by weight unless otherwise indicated.

### EXAMPLE

An axially segmented acicular mullite filter (Example 1) is prepared by extruding a monolithic honeycomb, and then cutting the resulting monolith into a cylindrical filter having a diameter of 11.0 cm and a length of 5.08 cm. The filter is skinned with an inorganic skin layer. The axially extending cells are plugged in an alternating pattern at each end to form inlet and outlet cells in a checkerboard pattern. Filter Example 1 has the following characteristics:

Porous wall effective permeability (κ): 3.55×10⁻¹² m².

Wall thickness (w): 448 μm.

Effective cell diameter (d): 2.07 mm.

Cell density (σ, calculated as 1/(w+d)²): 157,200 m⁻²

Axial cell length (L): 5.08×10⁻² m.

Rᵥ: 6.33×10⁶ m⁻¹.

Filter Example 1 is evaluated on an automobile having a GDI engine. The exhaust system of this vehicle has one flow-through three-way catalyst. Filter Example 1 is placed in a can mounted into the exhaust system downstream of the three-way catalyst. The vehicle is then operated on a roller chassis according to a well-defined legislative vehicle type approval cycle, the New European Driving Cycle (NEDC), while measuring gas consumption, hydrocarbon emissions, carbon dioxide emissions, NOx emissions, emitted particle mass and the number of emitted particles greater than 20 nm in size.

For comparison, Filter Example 1 is removed and the vehicle operated at identical conditions on the roller chassis. Table 1 reports the difference in performance of Filter Example 1 relative to the unfiltered vehicle.

Filter Examples 2, 3 and 4 are prepared in the same general manner as Filter Example 1, except the length is increased to 7.62 cm in the case of Example 2, 10.16 cm in the case of Example 3 and 12.7 cm in the case of Example 4. The porous wall effective permeability, wall thickness, effective cell diameter, cell density for Examples 2, 3 and 4 are all the same as Example 1. Rᵥ for Examples 2, 3 and 4 are 4.51×10⁶ m⁻¹, 3.93×10⁶ m⁻¹ and 3.76×10⁶ m⁻¹, respectively. These filters are tested in the same manner, and results (relative to the unfiltered vehicle) are as reported in Table 1.

Comparative Filters A, B and C are all made in the same general manner as Filter Examples 2, 3 and 4, respectively, except that the cell density in each case is approximately doubled to 301,000 m⁻². κ for each of Comparative Filters A, B and C is 3.70×10⁻¹² m². Rᵥ for Comparative Filters A, B and C are 6.29×10⁶ m⁻¹, 6.55×10⁶ m⁻¹ and 7.12×10⁶ m⁻¹ respectively. These filters are tested in the same manner, and results (relative to Control A) are as reported in Table 1.

TABLE 1

| | Δ HC | Δ CO | Δ NOx | Δ CO₂ | Δ Par- | Δ # of | Fuel Con- |
|---|---|---|---|---|---|---|---|
| Sam- | emis- | emis- | emis- | emis- | ticle | Par- | sumption, |
| ple | sions | sions | sions | sions | mass | ticles | L/100 km |
| Comp. | +6% | −17% | −47% | −4% | −83% | −96% | 7.55 |
| A | | | | | | | |
| Comp. | +4% | +1% | −50% | −3% | −79% | −92% | 7.62 |
| B | | | | | | | |
| Comp. | −24% | −19% | −50% | −3% | −81% | −95% | 7.62 |
| C | | | | | | | |
| 1 | +8% | −12% | −53% | 0 | −78% | −88% | 7.85 |
| 2 | −16% | −36% | −47% | −3% | −72% | −92% | 7.64 |
| 3 | −20% | −23% | −50% | −2% | −41% | −87% | 7.67 |
| 4 | −41% | −43% | −43% | 0 | −65% | −92% | 7.81 |

Δ HC emissions, Δ CO emissions, Δ NOx emissions, Δ CO₂ emissions, Δ Particle mass, Δ # of Particles refer to the change (in percent) in the emissions of hydrocarbons, carbon monoxide, NOx compounds, carbon dioxide, the mass of emitted particles and the number of emitted particles greater than 20 nm size, respectively, compared to the untreated emissions.

As can be seen from the data in Table 1, Filter Examples 1-4 all perform comparably to Comparative Samples A-C in terms of the number of particles removed. In all cases, the particle count is reduced below the Euro 5 standard for particle emissions for diesel light passenger vehicles. Reductions in NOx emissions are also comparable. However, a significant and unexpected improvement in both hydrocarbon and carbon monoxide emissions is seen with this invention at comparable length filters (Ex. 2 vs. Comp. A, Ex. 3 vs. Comp. B, Ex. 4 vs. Comp. C).

1. A method of removing particulate matter from the exhaust gas of a gasoline direct injection (GDI) engine, comprising introducing a particulate-laden exhaust gas into an inlet end of a ceramic honeycomb containing multiple axially-extending cells that are defined by intersecting porous walls, passing the exhaust gas through at least one such porous wall to trap the particulate matter in the porous wall, and then discharging the exhaust gas from an outlet end of the ceramic honeycomb, wherein
the porous walls of the ceramic honeycomb have a wall thickness of 150 to 750 μm, the honeycomb has an effective permeability of at least 0.8×10⁻¹² m² and the ceramic honeycomb contains from 45,000 to 230,000 cells per square meter of cross-sectional area.

2. The method of claim 1 wherein the effective permeability κ is from 1×10⁻¹² m² to 10×10⁻¹² m².

3. The method of claim 1 wherein the effective permeability κ is from 1×10⁻¹² m² to 5×10⁻¹² m².

4. The method of claim 1 wherein the wall thickness is 200 to 500 μm.

5. The method of claim 1 wherein the ceramic honeycomb has a cell density of 60,000 to 155,000 cells/m² of cross-sectional area.

6. The method of claim 1 wherein the cross-sectional shape of the cells is rectangular, triangular or square.

7. The method of claim 6 wherein the cross-sectional shape of the cells is square.

8. The method of claim 1, wherein the ceramic honeycomb is characterized in having a viscous resistance (Rᵥ) value of less than 2×10⁷ m⁻¹.

9. The method claim 1 wherein the ceramic honeycomb is one or more of acicular mullite, non-acicular mullite, cordierite, alumina, zirconia, silicon carbide, silicon nitride, aluminum nitride, silicon oxynitride, silicon carbonitride, beta spodumene, aluminum titanate, a strontium aluminum silicate, a lithium aluminum silicate, silica, a composite of any two or more thereof, or a composite of mullite fibers, alumina fibers, aluminosilicate fibers, aluminozirconia fibers and a binder.

10. The method of claim 9 wherein the ceramic honeycomb is acicular mullite, an acicular mullite-cordierite composite or an acicular mullite-tialite composite.

11. A gasoline direct fuel injection engine having an exhaust system comprising a ceramic honeycomb mounted therein such that exhaust gas from the engine passes through the ceramic honeycomb prior to being discharged from the exhaust system, wherein the ceramic honeycomb containing multiple axially-extending cells that are defined by intersecting porous walls, wherein the porous walls of the ceramic honeycomb have an effective permeability of at least 0.8×10⁻¹² m² and a wall thickness of 150 to 750 μm, and the ceramic honeycomb contains from 45,000 to 230,000 cells per square meter of cross-sectional area (i.e. has a cell density of 45,000 to 230,000/m²).

12. The gasoline direct fuel injection engine of claim 11 wherein the effective permeability κ is from 1×10⁻¹² m² to 10×10⁻¹² m².

13. The gasoline direct fuel injection engine of claim 11 wherein the effective permeability κ is from 1×10⁻¹² m² to 5×10⁻¹² m².

14. The gasoline direct fuel injection engine of claim 11 wherein the wall thickness is 200 to 500 μm.

15. The gasoline direct fuel injection engine of claim 11 wherein the ceramic honeycomb has a cell density of 60,000 to 155,000 cells/m² of cross-sectional area.

16. The gasoline direct fuel injection engine of claim 11 wherein the cross-sectional shape of the cells is rectangular, triangular or square.

17. The gasoline direct fuel injection engine of claim 16 wherein the cross-sectional shape of the cells is square.

18. The gasoline direct fuel injection engine of claim 11, wherein the ceramic honeycomb is characterized in having a viscous resistance (Rᵥ) value of less than 2×10⁷ m⁻¹.

19. The gasoline direct fuel injection engine of claim 11 wherein the ceramic honeycomb is one or more of acicular mullite, non-acicular mullite, cordierite, alumina, zirconia, silicon carbide, silicon nitride, aluminum nitride, silicon oxynitride, silicon carbonitride, beta spodumene, aluminum titanate, a strontium aluminum silicate, a lithium aluminum silicate, silica, a composite of any two or more thereof, or a composite of mullite fibers, alumina fibers, aluminosilicate fibers, aluminozirconia fibers and a binder.

20. The gasoline direct fuel injection engine of claim 19 wherein the ceramic honeycomb is acicular mullite, an acicular mullite-cordierite composite or an acicular mullite-tialite composite.
